(19) United States
(12) Patent Application Publication
(10) Pub. No.: US 2022/0271907 A1
(43) Pub. Date: Aug. 25, 2022

(54) MULTIBAND FDD (FREQUENCY DIVISION DUPLEX) RADIO CONFIGURATION FOR REDUCTION IN TRANSMIT AND RECEIVE PATH RESOURCES

(71) Applicant: Meta Platforms, Inc., Menlo Park, CA (US)

(72) Inventors: Kodanda Ram Reddy Engala, Irving, TX (US); Farbod Tabatabai, San Francisco, CA (US)

(21) Appl. No.: 17/179,567

(22) Filed: Feb. 19, 2021

(51) Int. Cl. H04L 5/14; H04J 1/08; H04J 1/14

(52) U.S. Cl. CPC H04L 5/14; H04J 1/08; H04J 1/14

(57) ABSTRACT

Apparatuses, methods, and systems for a multiband FDD radio configuration for reduction in transmit and receive path resources are disclosed. One apparatus includes an RF system-on-a-chip (RFSOC), a plurality of transmitter chains connected to a plurality of antennas, a plurality of receiver chains connected to the plurality of antennas, a plurality of transmit multiplexers, each of the plurality of transmit multiplexers receiving transmit signals from the RFSOC through a single transmit line and generating transmit signals for a sub-plurality of the transmitter chains through multiple transmit lines, wherein the transmit signals include multiple transmission frequency bands, and a plurality of receive multiplexers, each of the plurality of receive multiplexers receiving receive signals from a sub-plurality of the receiver chains through multiple receive lines and providing the receive signals to the RFSOC through a single receive line, wherein the receive signals include multiple receive frequency bands.

### FIELD OF THE DESCRIBED EMBODIMENTS

The described embodiments relate generally to wireless communications. More particularly, the described embodiments relate to systems, methods and apparatuses for a multiband FDD (frequency division duplex) radio configuration for reduction in transmit and receive path resources.

### BACKGROUND

An embodiment of a typical FDD (Frequency Division Duplex) multiband remote radio unit (RRU) base station includes one dedicated low power transmit path and a corresponding one dedicated receiver path for each of individual sub-bands that are supported.

It is desirable to have methods, apparatuses, and systems for a multiband FDD (frequency division duplex) radio configuration for reduction in transmit and receive path resources.

### SUMMARY

An embodiment includes a transceiver system. The transceiver system includes an RF system on a chip (RFSOC) including baseband communication circuitry and frequency upconverters and frequency downconverters for transmit and received wireless signals, a plurality of transmitter chains connected to a plurality of antennas, a plurality of receiver chains connected to the plurality of antennas, a plurality of transmit multiplexers, each of the plurality of transmit multiplexers receiving transmit signals from the RFSOC through a single transmit line and generating transmit signals for a sub-plurality of the transmitter chains through multiple transmit lines, wherein the transmit signals include multiple transmission frequency bands, and a plurality of receive multiplexers, each of the plurality of receive multiplexers receiving receive signals from a sub-plurality of the receiver chains through multiple receive lines and providing the receive signals to the RFSOC through a single receive line, wherein the receive signals include multiple receive frequency bands.

Another embodiment includes a method. The method includes frequency upconverting and frequency down-converting, by an RF system on a chip (RFSOC), transmit and received wireless signals, receiving, by a plurality of transmit multiplexer, transmit signals from the RFSOC through a single transmit line and generating transmit signals for a sub-plurality of a plurality of transmitter chains through multiple transmit lines, wherein the transmit signals include multiple transmission frequency bands, wherein the plurality of transmitter chains are connected to a plurality of antennas, and receiving, by a plurality of receive multiplexers, receive signals from a sub-plurality of the receiver chains through multiple receive lines and providing the receive signals to the RFSOC through a single receive line, wherein the receive signals include multiple receive frequency bands, wherein the plurality of receiver chains are connected to the plurality of antennas.

Other aspects and advantages of the described embodiments will become apparent from the following detailed description, taken in conjunction with the accompanying drawings, illustrating by way of example the principles of the described embodiments.

### BRIEF DESCRIPTION OF THE DRAWINGS

FIG. 1 shows an RRU (remote radio unit) and a BBU (baseband unit) of a mobile network, according to an embodiment.

FIG. 2 shows a block diagram of an RRU, according to an embodiment.

FIG. 3 shows another block diagram of an RRU, according to an embodiment.

FIG. 4 shows different beams formed for different frequency bands of an RRU, according to an embodiment.

FIG. 5 shows a frequency response of a transmit N-plexer and a frequency response of a receive N-plexer, according to an embodiment.

FIG. 6 shows a block diagram of a multiband TDD system (RRU), according to an embodiment.

FIG. 7 shows a timing diagram of controls of switches of multiband TDD system (RRU) of FIG. 6, according to an embodiment.

FIG. 8 shows another timing diagram of controls of the switches of multiband TDD system (RRU) of FIG. 6, according to an embodiment.

FIG. 9 shows a block diagram of a multiband TDD system (RRU) that supports more transmission of data traffic than reception of data traffic, according to an embodiment.

FIG. 10 is a flow chart that includes steps of a method for operating of an RRU, according to an embodiment.

### DETAILED DESCRIPTION

The embodiments described include methods, apparatuses, and systems for a multiband FDD (frequency division duplex) radio configuration for reduction in transmit and receive path resources of a RRU (remote radio unit).

Frequency division duplex (FDD) refers to duplex communication links where uplink (for example, RRU receive) and downlink (for example, RRU transmit) are at two different frequencies. For an embodiment, the uplink and downlink wireless links operate simultaneously. Further, for an embodiment, the transmission (that is, RRU transmission through the wireless downlink) and the reception (that is, RRU reception through the wireless uplink) are separated by a T/R spacing (that is, a frequency guard band). An RRU that supports wireless communication through more than one wireless frequency band simultaneously can be referred to as a Multiband RRU.

Currently, FDD multiband remote radio unit (RRU) base stations have one dedicated LPTX (low power Transmit) path and corresponding one dedicated RX (receiver) path for each of the individual sub-bands that are supported.

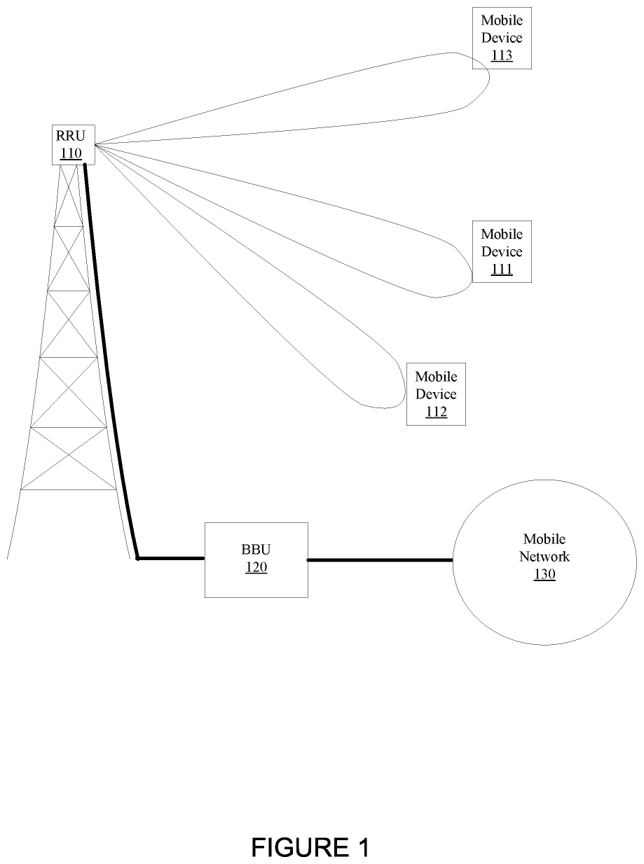

FIG. 1 shows an RRU (remote radio unit) 110 and a BBU (baseband unit) 120 of a mobile network 130, according to an embodiment. The mobile network 130 communicates with mobile devices 111, 112, 113 through the BBU and the RRU.

Traditional cellular, or Radio Access Networks (RAN), consist of many stand-alone base stations (BTS). For 3G (third generation of wireless mobile telecommunications technology), a distributed base station architecture was introduced by leading telecom equipment vendors. In this architecture the radio function unit, also known as the remote radio unit (RRU), is separated from the digital function unit, or baseband unit (BBU) by fiber. Digital baseband signals are carried over fiber, using the Open Base Station Architecture Initiative (OBSAI) or Common Public Radio Interface (CPRI) standard. The RRU can be installed on the top of tower close to the antenna, reducing the loss compared to the traditional base station where the RF signal has to travel through a long cable from the base station cabinet to the antenna at the top of the tower. The fiber link between RRH and BBU also allows more flexibility in network planning and deployment as they can be placed a few hundreds of meters or a few kilometers away. Most modern base stations now use this decoupled architecture.

A C-RAN (Cloud Radio Access Network) is made of a baseband unit (BBU), a remote radio unit (RRU), and a transport network that is also called a fronthaul. The BBU is a pool of centralized resources that function as a cloud or data center. The Remote Radio Unit (RRU) transmits RF signals and is connected to the Baseband Unit (BBU) through optical fibers. With advanced RF and antenna technologies, the RRU enables high-rate and low-latency data processing and significantly enhances eNodeB (3GPP's term for an LTE femtocell or Small Cell) capacity.

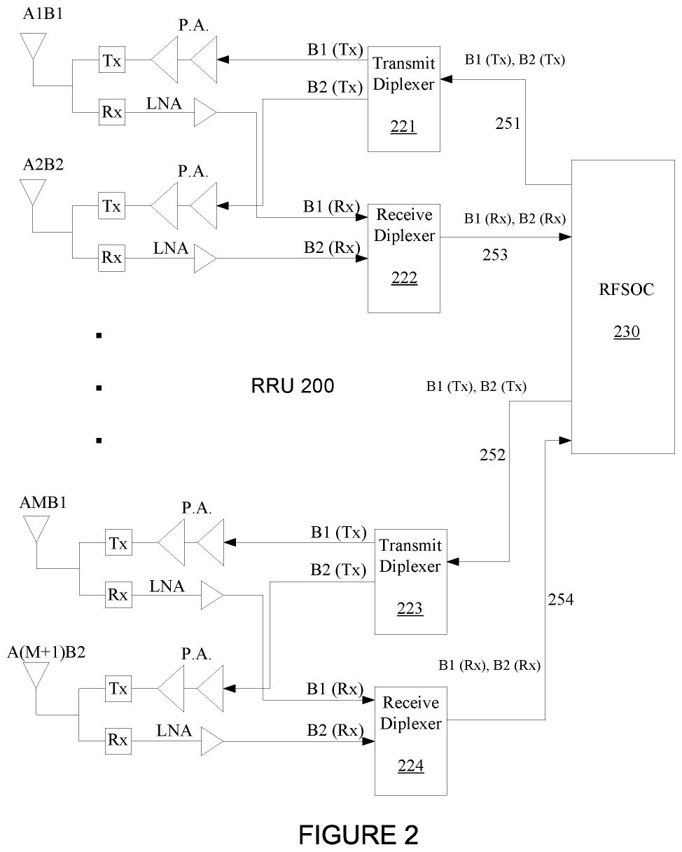

FIG. 2 shows a block diagram of an RRU 200, according to an embodiment. For an embodiment, the RRU 200 includes an RF system on a chip (RFSOC) 230. For an embodiment, the RFSOC includes baseband communication circuitry and frequency upconverters and frequency downconverters for transmit and received wireless signals.

For an embodiment, the RRU 200 further includes a plurality of transmitter chains connected to a plurality of antennas A1B1, A2B2, AMB1, A(M+1)B2, and a plurality of receiver chains also connected to the plurality of antennas A1B1, A2B2, AMB1, A(M+1)B2. While the plurality of transmitter chains and the plurality of receiver chains are shown to both be connected to the same plurality of antennas A1B1, A2B2, AMB1, A(M+1)B2, it is to be understood that the plurality of transmitter chains and the plurality of receiver chains can be connected to different sets of antennas.

For an embodiment, the transmitter chains include power amplifiers (P.A.s). For an embodiment, the receive chains include low-noise amplifiers (LNAs).

An embodiment includes a plurality of transmit multiplexers 221, 223. For an embodiment, each of the plurality of transmit multiplexers 221, 223 receive transmit signals from the RFSOC 230 through a single transmit line 251, 252 (shown carrying band 1 and band 2 transmit signals B1 (Tx), B2 (Tx)) and generate transmit signals for a sub-plurality of the transmitter chains through multiple transmit lines (one line carrying signal B1(Tx) and one line carrying signal B2(Tx)), wherein the transmit signals include multiple transmission frequency bands (B1(Tx), B2(Tx)).

An embodiment includes a plurality of receive multiplexers 222, 224, each of the plurality of receive multiplexers 222, 224 receive received signals from a sub-plurality of the receiver chains through multiple receive lines and providing the receive signals to the RFSOC 230 through a single receive line 253, 254, wherein the received signals include multiple receive frequency bands (B1 (Rx), B2 (Rx)).

For at least some embodiments, the RFSOC 230 is operable at a high enough frequency to process the transmit signals having the multiple frequency bands and the receive signals having the multiple frequency bands. The RFSOC 230 operable at this high of a frequency allows for a reduction in the transmit and receive path resources as described.

At least some of the described embodiments include an FDD multiband remote radio unit (RRU) base station that uses one LPTX (low-power transmitter chain) path and one RX (receive chain) path for both the multiple bands simultaneously at all times. These embodiments provide for the reduction of the LPTX and RX (transmit and receive paths) and corresponding FPGA (field programmable gate array) resources of the RFSOC 230 by half while still maintaining the same amount of data throughput. The RFSOC 230 operable at high enough of a frequency allows for generation of the multi-banded RF signals (transmit and receive). Further, inclusion of the transmit diplexers 221, 223, provides for separation of the multiple bands (B1 (Tx), B2(Tx)) before being provided to the power amplifiers (P.A.s) of the corresponding antennas. Similarly, for reception, the receive diplexers 222, 224 provide for combining of the multiple bands of receive signals (B1(Rx), B2(Rx) which are provided to the wide band RFSOC 230, thereby providing the reduced the LPTX/RX and FPGA resources by half without any reduction in system throughput.

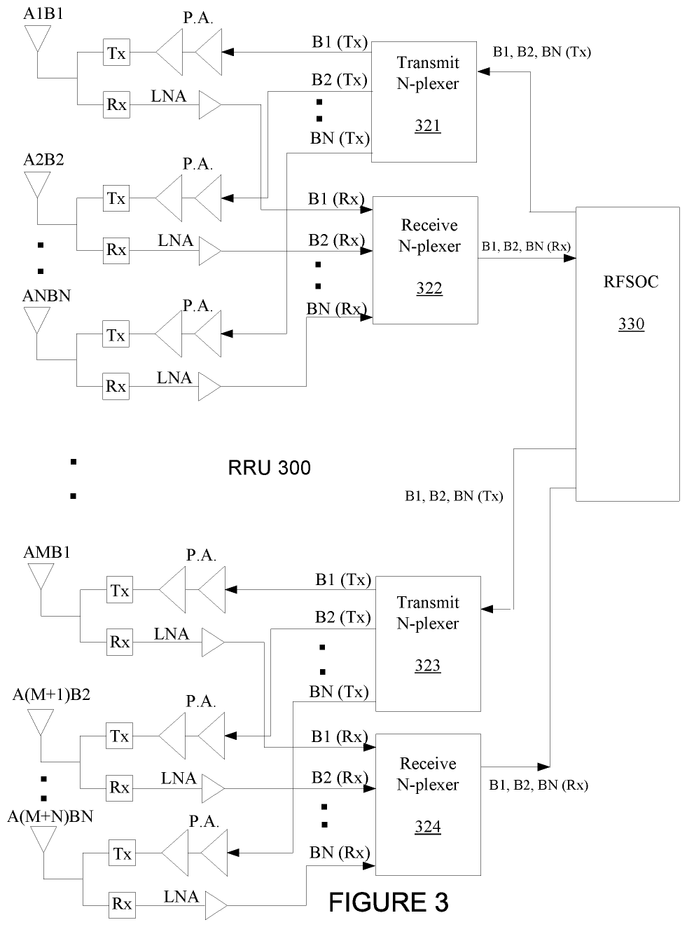

The described embodiments provide for conversion a single band RRU into a dual band, or triple band, or even more bands (as will be depicted in FIG. 3) depending on the individual band widths and the multiplexing/de-multiplexing technique limitations and thus reducing the LPTX and RX resources by half, one-third or even more. The reduction in resources is substantial in terms of BOM (bill of material) cost and the integrated circuit space needed. For 5G wireless network deployment, there is a huge demand for multi-band RRUs and mMIMO (massive multi-Input multi-Output) technology. Accordingly, the described embodiments provide for a saving of money and reduction in complexity. The described embodiments not only save BOM cost for LPTX and RX paths, the described embodiments also reduce the memory and processing resources (for example, of the FPGA of the RFSOC 230). Further, the described embodiments provide for a reduction in the overall DC power consumption of the RRU. The cost of the mMIMO unit also improves due to the fewer number of active paths and the reduced silicon resources. This reduces the overall operational cost for the network operators and is also better for the environment.

As will be described, for an embodiment, each of the transmit multiplexers include electronic circuitry for frequency matching at each of the multiple transmission frequency bands. Further, as will be described, each of the receive multiplexers include electronic circuitry for frequency matching at each of the multiple receive frequency bands.

As the wireless communication is FDD, each of the multiple transmission frequency bands has a corresponding one of the multiple receive frequency bands. Further, for an embodiment, a one of the transmitter chains operates to transmit a wireless signal through one of the multiple transmission frequency band simultaneous with a one of the receiver chains operating to receive a wireless signal through one of the multiple receive frequency bands.

FIG. 3 shows another block diagram of an RRU 300, according to an embodiment. For this embodiment, additional bands (BN) are included for both the transmit paths and the receive paths. As shown, transmit N-plexers 321, 322 receive the multiple bands B1, B2, . . . BN transmit signals bands over a single line connected to the RFSOC 330, and generate N separate signals, wherein each of the N separate signals includes a corresponding one of the N bands B1, B2, . . . BN. Each of the N separate signals of the transmit N-plexer 321 is provided to a corresponding one of N transmit chains which are connected to corresponding N antennas A1B1, A2B2, . . . ANBN. Each of the N separate signals of the transmit N-plexer 323 is provided to a corresponding one of N transmit chains which are connected to corresponding N antennas AMB1, A(M+1)B2, . . . A(M+N)BN.

Further, as shown, receive N-plexers 322, 324 receive N separate signals, wherein each of the N separate received signals includes a corresponding one of the N bands B1, B2, . . . BN. Each of the N separated received signals of the receive N-plexer 322 are received over a corresponding one of N antennas A1B1, A2B2, . . . ANBN. Each of the N separated received signals of the receive N-plexer 324 are received over a corresponding one of N antennas AMB1, A(M+1)B2, . . . A(M+N)BN. Each of the receive N-plexers 322, 324 generates the multiple bands B1, B2, BN transmit signals bands over a single line connected to the RFSOC 330.

While only two transmit N-plexers 321, 323 and only two receive N-plexers 322, 324 are shown, it is to be understood that at least some embodiments include any number of possible transmit N-plexers and receive N-plexers. The embodiment of FIG. 3 that includes N transmit bands B1, B2, BN (Tx) and the N receive bands B1, B2, BN (RX) provides a reduction of the LPTX and RX resources by approximately N.

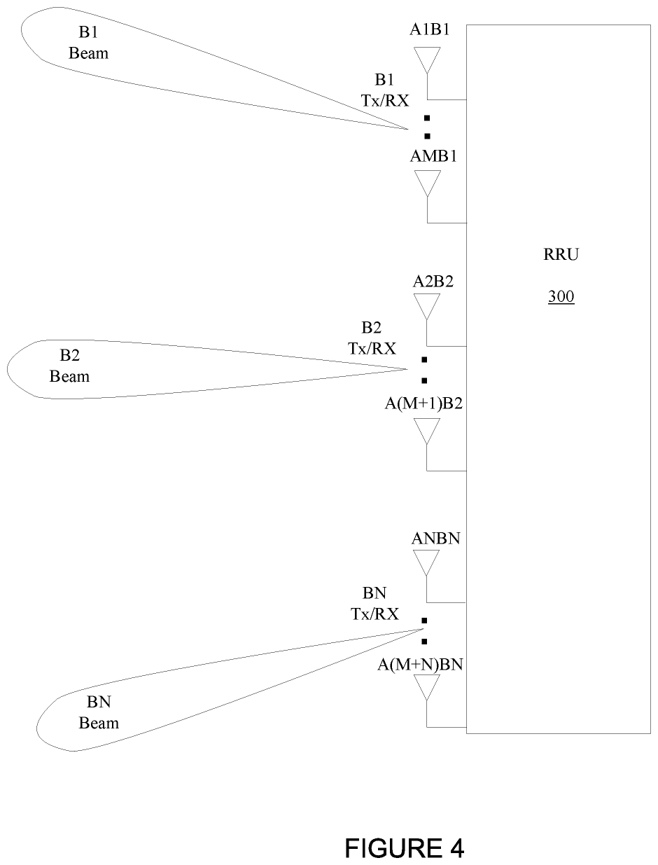

FIG. 4 shows different beams formed for different frequency bands of an RRU, according to an embodiment. For an embodiment, the transmit signals generate a separate transmission beam for each of the multiple transmission frequency bands, and a corresponding reception beam for one of the multiple receive frequency bands. FIG. 4 shows the antennas of A1B1, A2B2, . . . ANBN, and antennas AMB1, A(M+1)B2, . . . A(M+N)BN rearranged to illustrate that the multiple antennas dedicated to each of the bands B1, B2, . . . BN provides or allows for a separate beam to be formed for each of the bands. Therefore, a separate direction for each of the directional bands can be realized for each of the N bands B1, B2, . . . BN. For an embodiment, the directional beam (B1 Beam, B2 Beam, BN Beam) for each of the N bands B1, B2, . . . BN is realized or formed for both the transmit bands B1, B2, . . . BN (Tx) and the receive bands B1, B2, . . . B3 (Rx). The beam directions for each of the separate bands can be controlled by selecting phase and amplitude adjustments for the multiple transmit and receive signals for each of the transmit bands B1, B2, . . . BN (Tx) and the receive bands B1, B2, . . . B3 (Rx).

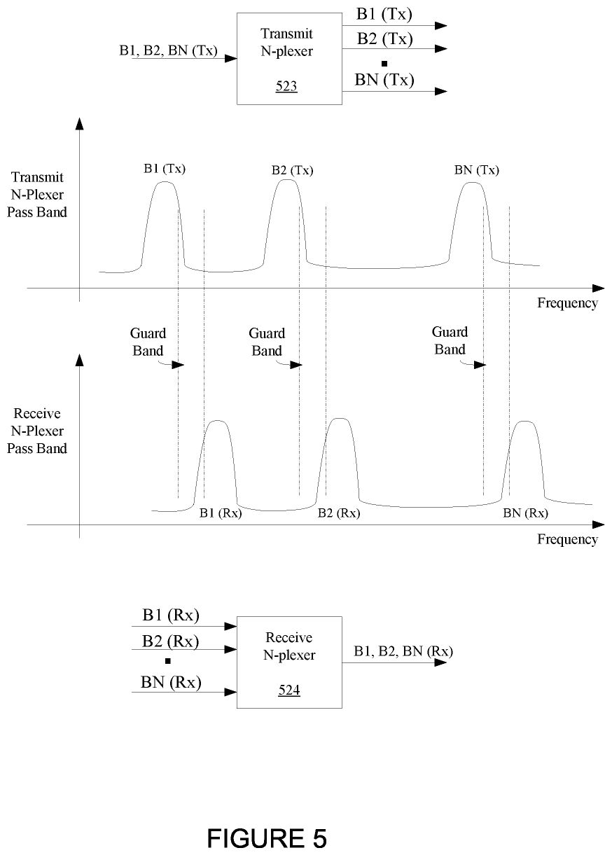

FIG. 5 shows a frequency response of a transmit N-plexer 523 and a frequency response of a receive N-plexer 525, according to an embodiment. For an embodiment, the diplexers 221, 222, 223, 224 are 3-port device that have a common port (Port1) and 2 different frequency ports (Port2 and Port3). The diplexer is bi-directional device and can be used in both transmit and receive scenarios. For the transmit diplexers 221, 223, a combined multiple band signal (B1 (Tx), B2 (Tx)) in the frequency domain is input at the common port (Port1) and only the respective/individual band signals (B1(Tx), B2(Tx)) are obtained separately at the output of the diplexer (Port2 & Port3). The amount of rejection and fidelity between the bands depends on the design quality of the diplexer and the requirements. At the common port, since the desired signal is multi-band, the input return loss of this port must be good over the combined range of the multiband signal. Similarly, at the individual ports the return loss must be good over the respective frequency bands.

For the receive diplexers 222, 224, only individual band signals (B1, B2 (Rx)) are input at the respective band ports (Port2 & Port3) and the combined multi-band signal is obtained at the common port (Port1)

For at least some embodiments, the N-plexers 321, 322, 323, 324 are (N+1) port device that have a common port (Port1) and multiple different frequency ports (Port2, Port3 . . . Port(N+1)). The multiplexer is bi-directional device and can be used in both transmission and reception of wireless signals.

For the transmit N-plexers 321, 323, a combined multiple band signal (B1, B2, . . . BN) in the frequency domain is input at the common port (Port1) and only the respective/individual band signals (B1, B2, . . . BN) are obtained separately at the output of the multiplexer (Port2, Port3 . . . Port(N+1)). The amount of rejection and fidelity between the bands depends on the design quality of the diplexer and the requirements. At the common port, since the desired signal is multi-band, the input return loss of this port must be good over the combined range of the multi-band signal (B1, B2, . . . BN). Similarly, at the individual ports the return loss must be good over the respective frequency bands.

For the receive N-plexers 322, 324, only individual band signals (B1, B2, . . . BN) are input at the respective band ports (Port2, Port3 . . . Port(N+1)) and the combined multi-band signal (B1, B2, . . . BN) is obtained at the common port (Port1).

FIG. 5 shows an exemplary transmit N-plexer 523 that receives the single input that includes the N bands (B1, B2, BN) at the common port and generates the N separate outputs B1 (Tx), B2 (Tx), . . . BN (Tx). A corresponding frequency response of the pass bands of the exemplary transmit N-plexer 523 is shown below the exemplary transmit N-plexer 523. The passband includes passbands at B1 (Tx), B2 (Tx), . . . BN (Tx).

FIG. 5 also shows an exemplary receive N-plexer 524 the receives the N separate receive signals B1 (Rx), B2 (Rx), . . . BN (Rx) and generates the single output that includes the N bands B1 (Rx), B2 (Rx), . . . BN (Rx). A corresponding frequency response of the pass bands of the exemplary receive N-plexer 524 is shown above the exemplary receive N-plexer 524. The passband includes passbands at B1 (Rx), B2 (Rx), . . . BN (TRx). A guard band is between each of the transmit bands B1 (Tx), B2 (Tx), . . . BN (Tx) and the receive bands B1 (Rx), B2 (Rx), . . . BN (Rx). The guard band includes a small portion of the frequency domain that is allocated between the transmit signals and the receive signals within a band. For example, the guard band is located in the frequency domain between the passbands of B1(Tx) and B1(Rx), between the passbands of B2(Tx) and B2(Rx), and between the passbands of BN(Tx) and BN(Rx).

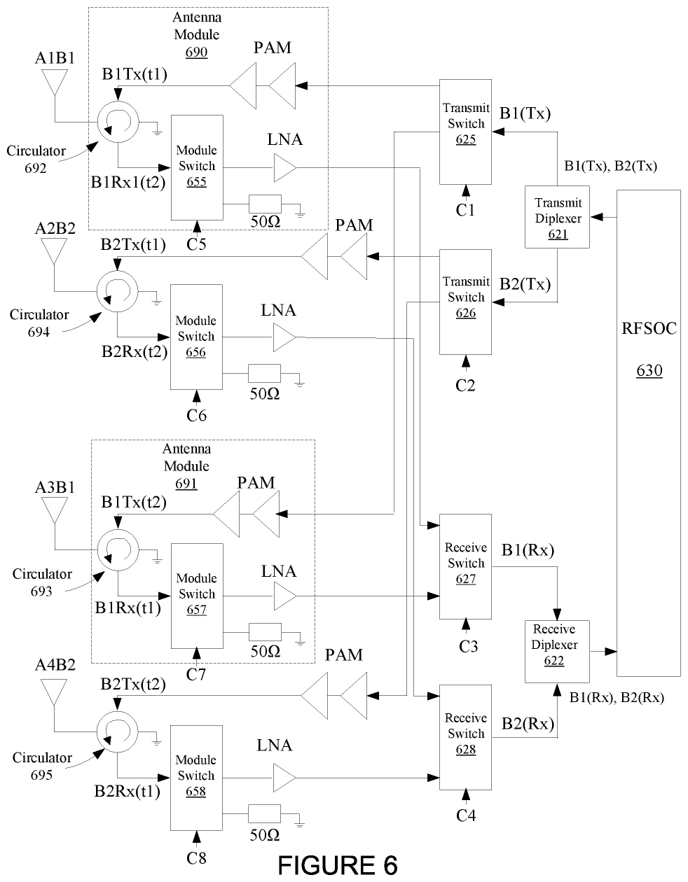

FIG. 6 shows a block diagram of a multiband TDD system (RRU), according to an embodiment. The embodiment of FIG. 6 further includes a plurality transmit switches 625, 626 associated with each transmit multiplexer 621. While only one transmit multiplexer 621 is shown in FIG. 6, it is to be understood that at least some embodiments include multiple transmit multiplexers.

For an embodiment, a first transmit switch 625 of the plurality of transmit switches 625, 626 operates (or is configured to) to connect a first band (B1(Tx)) of the multiple transmission frequency bands (B1(Tx), B2(Tx)) to a first transmitter chain (which feeds or is connected to antenna A1B1) of the plurality of transmitter chains or connect the first band (B1(Tx)) of the multiple transmission frequency bands (B1(Tx), B2(Tx)) to a third transmitter chain (which feeds or is connected to antenna A3B1) of the plurality of transmitter chains.

For an embodiment, a second transmit switch 626 of the plurality of transmit switches 625, 626 operates (or is configured to) to connect a second band (B2(Tx)) of the multiple transmission frequency bands (B1(Tx), B2(Tx)) to a second transmitter chain (which feeds or is connected to antenna A2B2) of the plurality of transmitter chains or connect the second band (B2(Tx)) of the multiple transmission frequency bands (B1(Tx), B2(Tx)) to a fourth transmitter chain (which feeds or is connected to antenna A4B2) of the plurality of transmitter chains.

Again, while only two transmit frequency bands (B1(Tx), B2(Tx)) are shown in FIG. 6, it is to be understood that at least some embodiments further include N transmit frequency bands.

The embodiment of FIG. 6 further includes a plurality receiver switches 627, 628 associated with each receive multiplexer 622. While only one receive multiplexer 622 is shown in FIG. 6, it is to be understood that at least some embodiments include multiple transmit multiplexers.

For an embodiment, the first receiver switch 627 of the plurality of receiver switches 627, 628 operates to connect a first band (B1(Rx) of the multiple receiver frequency bands (B1(Rx, B2(Rx)) from a first receive chain (which fed by or is connected to antenna A1B1) of the plurality of receiver chains associated (that is, corresponds with) with the first transmitter chain or connects the first band (B1(Rx) of the multiple transmission frequency bands (B1(Rx, B2(Rx)) from a third receiver chain (which fed by or is connected to antenna A3B1) of the plurality of receiver chains associated with the third transmitter chain.

For an embodiment, the second receiver switch 628 of the plurality of receiver switches 627, 628 operates to connect a second band (B2(Rx) of the multiple receiver frequency bands (B1(Rx, B2(Rx)) from a second receiver chain (which fed by or is connected to antenna A2B2) of the plurality of receiver chains associated with the second transmitter chain or connect the second band (B2(Rx) of the multiple receive frequency bands (B1(Rx, B2(Rx)) from a fourth receiver chain (which fed by or is connected to antenna A4B2) of the plurality of receiver chains associated with the fourth transmitter chain.

Again, while only two receive frequency bands (B1(Rx), B2(Rx)) are shown in FIG. 6, it is to be understood that at least some embodiments further include N receive frequency bands.

FIG. 6 further includes antenna modules associated with each of the antennas A1B1, A2B2, A3B1, A4B2. Two such antenna modules 690, 691 are shown in FIG. 6.

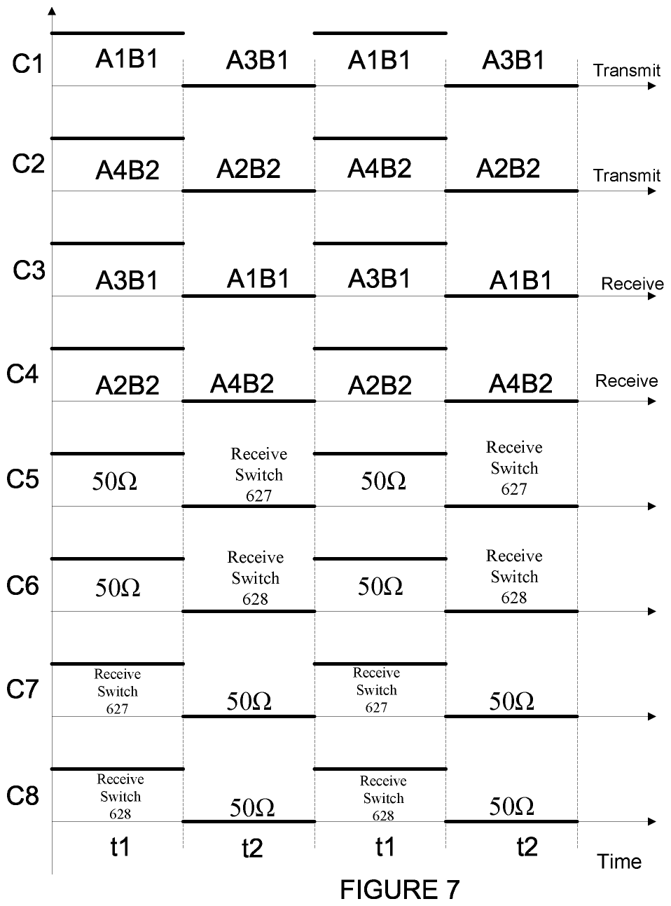

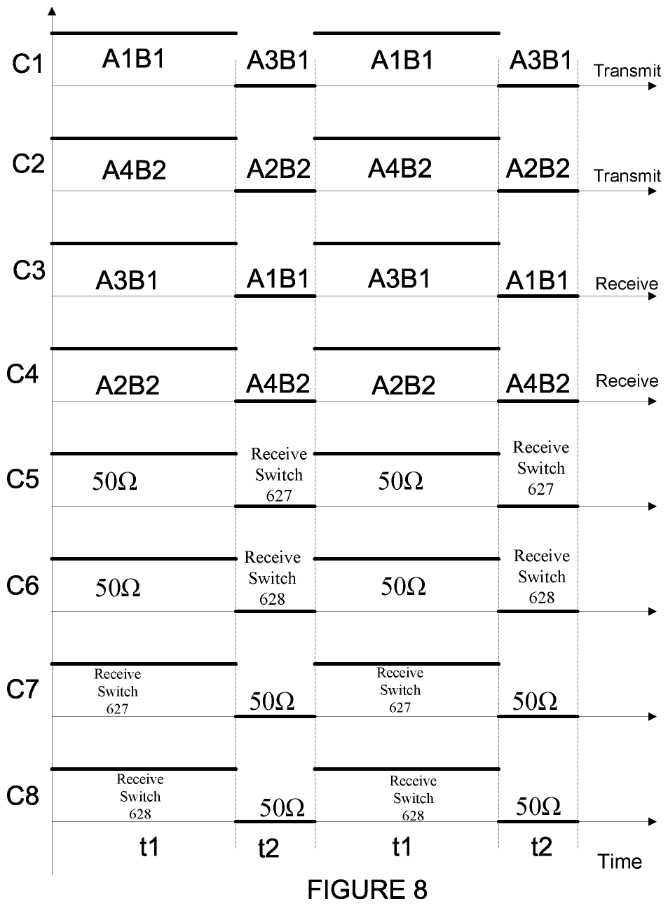

For an embodiment, a first antenna module 690 includes a first circulator 692 configured to couple a first transmit signal B1Tx(t1) of the first transmit switch 625 to a first antenna A1B1 of the plurality of antennas, and couple a first receive signal B1Rx(t2) of the first antenna A1B1 of the plurality of antennas to the first receive switch 627 through a first module switch 655. Further, for at least some embodiments, the first module switch 655 is configured to connect an input (an output of the circulator 692) to the first module switch 655 to a matched impedance (designated as 50Ω) during a first period of time (designated as t1 in FIGS. 7 and 8), and connect the first receive signal B1(Rx) of the first antenna (A1B1) of the plurality of antennas to the first receive switch 627 during a second period of time (designated as t2 in FIGS. 7 and 8).

For an embodiment, a second antenna module 691 includes a second circulator 693 configured to couple a second transmit signal B1Tx(t2) of the first transmit switch 625 to a second antenna (A3B1) of the plurality of antennas, and couple a second receive signal B1Rx(t1) of the second antenna A3B1 of the plurality of antennas to the first receive switch 627 through a second module switch 657. Further, for at least some embodiments, the second module switch 657 is configured to connect an input to the second module switch to a matched impedance (designated as 50Ω) during the second period of time (designated as t2 in FIGS. 7 and 8), and connect the second received signal B1Rx(t1) of the second antenna (A3B1) of the plurality of antennas to the first receive switch 627 during the first period of time (designated as t1 in FIGS. 7 and 8).

The second transmit switch 626 and the second receive switch 628 operate in a similar fashion as described for the first transmit switch 625 and the first receive switch 627. The second transmit switch 626 and the second receive switch 628 are controllably operated with antenna modules associated with the antennas A2B2, A4B2, wherein the antenna modules associated with antennas A2B2, A4B2 include circulators 694, 695 and module switches 656, 658.

As shown, the first and second transmit switches 625, 627, and first and second receive switches 626, 628 are controlled by C1, C2, C3, C4. Further, module switches 655, 656, 657, 658 are controlled by C5, C6, C7, C8. Timing of the controls C1, C2, C3, C4, C5, C6, C7, C8 are shown in FIGS. 7 and 8.

FIG. 7 shows a timing diagram of controls of the switches of multiband TDD system (RRU) of FIG. 6, according to an embodiment. C1 controls the switch settings of the first transmit switch 625. C2 controls the switch settings of the second transmit switch 626. C3 controls the switch settings of the first receive switch 627. C4 controls the switch settings of the second receive switch 628. C5 controls the switch settings of the module switch 655. C6 controls the switch settings of the module switch 656. C7 controls the switch settings of the module switch 657. C8 controls the switch settings of the module switch 658.

As shown and as will be described, the embodiment of FIG. 6 greatly reduces transmit and receive path resources because two transmit chains and two receive chains are supported by a single transmit connection and a single receive connection to the RFSOC 630. Further, while only a single transmit duplexer 621 and a single receive diplexer 622 are shown, other embodiments include more than the single transmit duplexer 621 and a single receive diplexer 622. Further, while only two transmit bands (B1(Tx), B2(Tx)) and two receive bands (B1(Rx), B2(Rx)) are shown, other embodiments include more transmit and receive bands.

For at least some embodiments, the first transmit switch 625 is controlled by C1 to connect the first transmit signal (B1(Tx) at t1) to the first antenna A1B1 through the first antenna module 690 during the first period (t1), and configured to connect the second transmit signal (B1(T(x) at time t2) to the second antenna A3B1 through the second antenna module 691 during the second period (t2). That is, during the first time periods (t1) the first transmit switch is controlled by C1 to connect B1(Tx) to antenna A1B1, and during the second time periods (t2) the first transmit switch 625 is controlled by C1 to connect B1(Tx) to antenna A3B1.

Further, for at least some embodiments, the first receive switch 627 is controlled by C3 to connect the first receive signal (B1(Rx at t1) of the second module 691 to the RFSOC 630 to during the first period (t1), and configured to connect the second received signal (B1(Rx) at t2) of the first antenna module 690 to the RFSOC 630 during the second period (t2).

Further, for at least some embodiments, the second transmit switch 626 is controlled by C2 to connect a third transmit signal (B2(Tx) at t1) to a third antenna A2B3 through a third antenna module (not shown) during the first period (t1), and configured to connect a fourth transmit signal (B2(T(x) at time t2) to a fourth antenna A4B2 through a fourth antenna module (not shown) during the second period (t2). That is, during the first time periods (t1) the second transmit switch 626 is controlled by C2 to connect B2(Tx) to antenna A2B2, and during the second time periods (t2) the second transmit switch 626 is controlled by C2 to connect B2(Tx) to antenna A4B2.

Further, for at least some embodiments, the second receive switch 628 is controlled by C4 to connect a third receive signal (B2(Rx at t1) of the third module to the RFSOC 630 to during the first period (t1), and configured to connect a fourth received signal (B2(Rx) at t2) of the third antenna module to the RFSOC 630 during the second period (t2).

As shown, the module switches 655, 656, 657, 658 are controlled by C5, C6, C7, C8, wherein the control is synchronized with the control of the transmit switches 625, 626 and the receive switches 627, 628. For an embodiment, the module switch 655 of the first antenna module 690 is controlled by C5 to connect the output of the module switch 655 to a matched impedance (shown as 50Ω) during the first periods t1. That is, the transmit switch 625 is controlled by C1 to connect the first transmit signal (B1(Tx) at t1) to the first antenna A1B1 through the first antenna module 690 during the first period (t1). Accordingly, the first antenna A1B1 is transmitting the first transmit signal (B1(Tx) at t1), and the output of the circulator 692 should be connected to the matched impedance. For an embodiment, the module switch 655 of the first antenna module 690 is controlled by C1 to connect the output of the module switch 655 to the receive switch 627 during the second periods of time. That is, the first receive switch 627 is controlled by C3 to connect the second received signal (B1(Rx) at t2) of the first antenna module 690 to the RFSOC 630 during the second periods (t2). Accordingly, the first antenna A1B1 is receiving the second received signal (B1(Rx) at t2), and the output of the circulator 692 should be connected to the receive switch 627.

For an embodiment, the module switch 657 of the second antenna module 691 is controlled to connect the output of the module switch 657 to the receive switch 627 during the first periods of time. That is, the first receive switch 627 is controlled by C3 to connect the received signal (B1(Rx) at t1) of the third antenna module 691 to the RFSOC 630 during the first periods (t1). Accordingly, the first antenna A3B1 is receiving the received signal (B1(Rx) at t1), and the output of the circulator 693 should be connected to the receive switch 627. For an embodiment, the module switch 657 of the second antenna module 690 is controlled by C7 to connect the output of the module switch 657 to a matched impedance (shown as 50Ω) during the second periods t2. That is, the transmit switch 627 is controlled by C3 to connect the second transmit signal (B1(Tx) at t2) to the second antenna A3B1 through the second antenna module 691 during the second period (t2). Accordingly, the second antenna A3B2 is transmitting the second transmit signal (B1(Tx) at t2), and the output of the circulator 693 should be connected to the matched impedance.

FIG. 8 shows another timing diagram of controls of the switches of multiband TDD system (RRU) of FIG. 6, according to an embodiment. For an embodiment, the timing of the controls of C1, C2, C3, C4, C5, C6, C7, C8 does not have to have the 50% duty cycle as shown in FIG. 7. In some situation is may be desirable to transmit certain of the bands (B1, B2) over certain of the plurality of antennas (A1, A2, A3, A4) for greater amounts of time than other of the antennas (A1, A2, A3, A4).

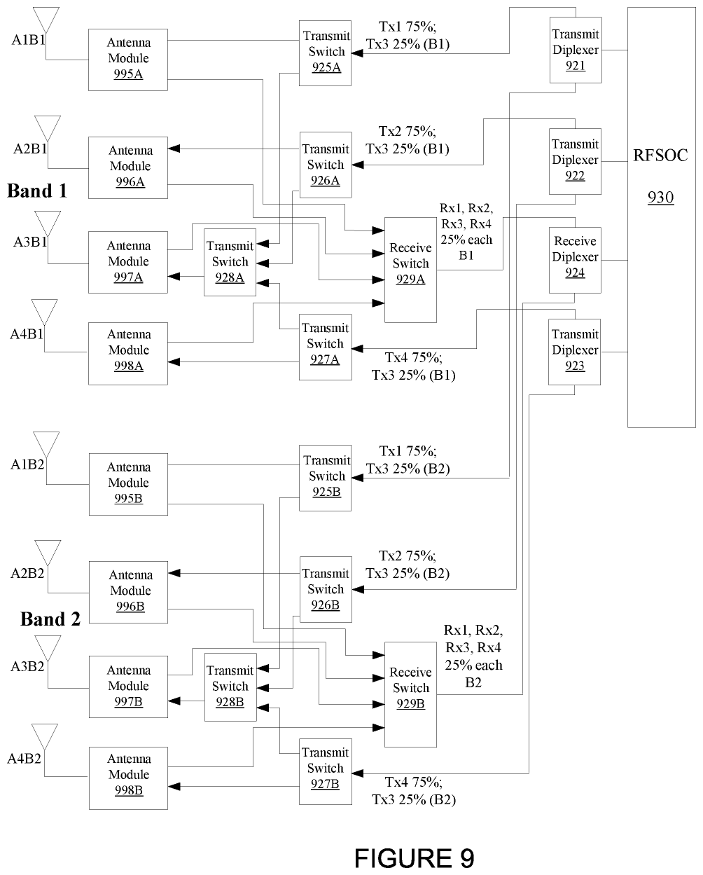

FIG. 9 shows a block diagram of a multiband TDD system (RRU) that supports more transmission of data traffic than reception of data traffic, according to an embodiment. In some situation it may be determined that a particular RRU will be primarily transmitting data traffic rather than receiving data traffic, or determined to be primarily receiving data traffic rather than transmitting data traffic. These asymmetrical wireless link communication systems can be accommodated by including more transmit multiplexers than receive multiplexers, or more receive multiplexers than transmit multiplexers, and more transmit switches than receive switches, or more receive switches than transmit switches. For an embodiment, the system includes more transmit multiplexer when the system is configured to transmit wireless communication a majority of time, and wherein the system includes more receive multiplexers when the system is configured to receive wireless communication a majority of time.

The block diagram of FIG. 9 includes transmit multiplexers 921, 922, 923, wherein each of the plurality of transmit multiplexers 921, 922, 923 receives transmit signals from the RFSOC 930 through a single transmit line and generates transmit signals for a sub-plurality of the transmitter chains through multiple transmit lines, wherein the transmit signals include multiple transmission frequency bands (B1, B2). As shown, a first transmit multiplexer 921 receives through a single line a band 1 (B1) signal with 75% of the time dedicated to antenna A1B1 and 25% of the time dedicated antenna A3B1, and a band 2 (B2) signal with 75% of the time dedicated to antenna A1B2 and 25% of the time dedicated antenna A3B2. The transmit diplexer 921 generates the B1 signal for antennas A1B1 and A3B1, and generates the B2 signal for antenna A1B2 and A3B2.

As shown, a second transmit multiplexer 922 receives through a single line a band 1 (B1) signal with 75% of the time dedicated to antenna A2B1 and 25% of the time dedicated antenna A3B1, and a band 2 (B2) signal with 75% of the time dedicated to antenna A2B2 and 25% of the time dedicated antenna A3B2. The transmit diplexer 921 generates the B1 signal for antennas A2B1 and A3B1, and generates the B2 signal for antenna A2B2 and A3B2.

As shown, a third transmit multiplexer 923 receives through a single line a band 1 (B1) signal with 75% of the time dedicated to antenna A4B1 and 25% of the time dedicated antenna A3B1, and a band 2 (B2) signal with 75% of the time dedicated to antenna A4B2 and 25% of the time dedicated antenna A3B2. The transmit diplexer 921 generates the B1 signal for antennas A4B1 and A3B1, and generates the B2 signal for antenna A4B2 and A3B2.

The block diagram of FIG. 9 includes 6 transmit switches 925A, 926A, 927A, 925B, 926B, 927B. The transmit switch 925A receives the Band 1 (B1) output of the first transmit diplexer 921, and controls the 75% timing distribution of the output of the Band 1 (B1) output of the first transmit diplexer 921 to antenna A1B1 through the antenna module 995A, and the 25% timing distribution to antenna A3B1 through secondary transmit switch 928A and through the antenna module 997A. The transmit switch 926A receives the Band 1 (B1) output of the second transmit diplexer 922, and controls the 75% timing distribution of the output of the Band 1 (B1) output of the second transmit diplexer 922 to antenna A2B1 through the antenna module 996A, and the 25% timing distribution to antenna A3B1 through the secondary transmit switch 928A and through the antenna module 997A. The transmit switch 927A receives the Band 1 (B1) output of the third transmit diplexer 923, and controls the 75% timing distribution of the output of the Band 1 (B1) output of the third transmit diplexer 923 to antenna A4B1 through the antenna module 998A, and the 25% timing distribution to antenna A3B1 through the secondary transmit switch 928A and through the antenna module 997A.

The transmit switch 925B receives the Band 2 (B2) output of the first transmit diplexer 921, and controls the 75% timing distribution of the output of the Band 2 (B2) output of the first transmit diplexer 921 to antenna A1B2 through the antenna module 995B, and the 25% timing distribution to antenna A3B2 through secondary transmit switch 928B and through the antenna module 997B. The transmit switch 926B receives the Band 2 (B2) output of the second transmit diplexer 922, and controls the 75% timing distribution of the output of the Band 2 (B2) output of the second transmit diplexer 922 to antenna A2B2 through the antenna module 996B, and the 25% timing distribution to antenna A3B2 through the secondary transmit switch 928B and through the antenna module 997B. The transmit switch 927B receives the Band 2 (B2) output of the third transmit diplexer 923, and controls the 75% timing distribution of the output of the Band 2 (B2) output of the third transmit diplexer 923 to antenna A4B2 through the antenna module 998B, and the 25% timing distribution to antenna A3B2 through the secondary transmit switch 928B and through the antenna module 997B.

The block diagram of FIG. 9 includes 2 receive switches 929A, 929B. The receive switch 929A receives the Band 1 (B1) receive signals from the antennas A1B1, A2B1, A3B1, A4B1 at a time duration of 25% each. The antennas A1B1, A2B1, A3B1, A4B1 are operative to transmit 75% of the time, and receive wireless signals that are each coupled to the receive switch 929A 25% of the time. The receive switch 929B receives the Band 2 (B2) receive signals from the antennas A1B2, A2B2, A3B2, A4B2 at a time duration of 25% each. The antennas A1B2, A2B2, A3B2, A4B2 are operative to transmit 75% of the time, and receive wireless signals that are each coupled to the receive switch 929B 25% of the time.

The outputs of the receive switches 929A, 929B are connected to the receive multiplexer 924 which provides the signal receive over the two bands (B1, B2) to the RFSOC 930 over a single line.

While the RRU of FIG. 9 includes more transmit diplexers than receive diplexers, it is to be understood that if the RRU will be deployed to receive communication more than the RRU transmits communication, an embodiment includes more receive diplexers than transmit diplexers. As previously described, each of the plurality of receive multiplexers receiving receive signals from a sub-plurality of the receiver chains through multiple receive lines and providing the receive signals to the RFSOC through a single receive line, wherein the receive signals include multiple receive frequency bands. A similar arrangement as shown for the greater amount of transmit diplexers of FIG. 9 can be created for the greater amount of receive diplexers.

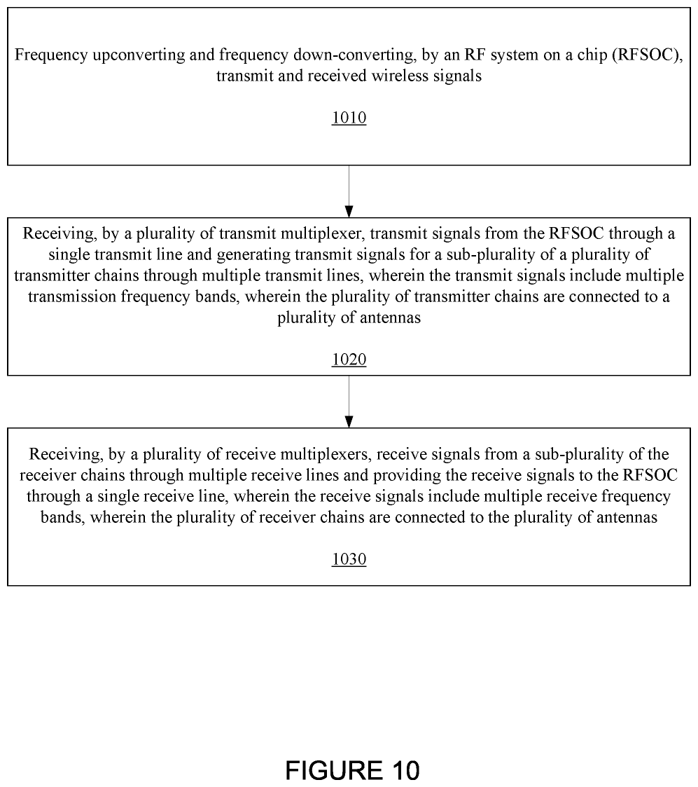

FIG. 10 is a flow chart that includes steps of a method for operating of an RRU, according to an embodiment. A first step 910 includes frequency upconverting and frequency down-converting, by an RF system on a chip (RFSOC), transmit and received wireless signals. A second step 920 includes receiving, by a plurality of transmit multiplexer, transmit signals from the RFSOC through a single transmit line and generating transmit signals for a sub-plurality of a plurality of transmitter chains through multiple transmit lines, wherein the transmit signals include multiple transmission frequency bands, wherein the plurality of transmitter chains are connected to a plurality of antennas. A third step 930 includes receiving, by a plurality of receive multiplexers, receive signals from a sub-plurality of the receiver chains through multiple receive lines and providing the receive signals to the RFSOC through a single receive line, wherein the receive signals include multiple receive frequency bands, wherein the plurality of receiver chains are connected to the plurality of antennas.

As previously described, for an embodiment, the transmit signals generate a separate transmission beam for each of the multiple transmission frequency bands, and a corresponding one of the multiple receive frequency bands.

As previously described, for an embodiment, each of the transmit multiplexers include electronic circuitry for frequency matching at each of the multiple transmit frequency bands, and each of the receive multiplexers include electronic circuitry for frequency matching at each of the multiple receive frequency bands.

As previously described, for an embodiment, each of the multiple transmission frequency bands has a corresponding one of the multiple receive frequency bands. As previously described, for an embodiment, a one of the transmitter chains operates to transmit a wireless signal through one of the multiple transmission frequency band simultaneous with a one of the receiver chains operating to receive a wireless signal through one of the multiple receive frequency bands.

As previously described, for an embodiment, a plurality transmit switches is associated with each transmit multiplexer, and further includes a first transmit switch of the plurality of transmit switches operating to connect a first band of the multiple transmission frequency bands to a first transmitter chain of the plurality of transmitter chains or connect the first band of the multiple transmission frequency bands to a third transmitter chain of the plurality of transmitter chains, and a second transmit switch of the plurality of transmit switches operating to connect a second band of the multiple transmission frequency bands to a second transmitter chain of the plurality of transmitter chains or connect the second band of the multiple transmission frequency bands to a fourth transmitter chain of the plurality of transmitter chains.

As previously described, for an embodiment, a plurality receiver switches is associated with each receive multiplexer, and further includes a first receiver switch of the plurality of receiver switches operating to connect a first band of the multiple receiver frequency bands from a first receive chain of the plurality of receiver chains associated with the first transmitter chain or connect the first band of the multiple transmission frequency bands from a third receiver chain of the plurality of receiver chains associated with the third transmitter chain, and a second receiver switch of the plurality of receiver switches operating to connect a second band of the multiple receiver frequency bands from a second receiver chain of the plurality of receiver chains associated with the second transmitter chain or connect the second band of the multiple receive frequency bands from a fourth receiver chain of the plurality of receiver chains associated with the fourth transmitter chain.

As previously described, for an embodiment, the system includes more transmit multiplexer when the system is configured to transmit wireless communication a majority of time, and the system includes more receive multiplexers when the system is configured to receive wireless communication a majority of time.

As previously described, at least some embodiments further include a first antenna module and a second antenna module. For an embodiment, the first antenna module includes a first circulator configured to couple a first transmit signal of the first transmit switch to a first antenna of the plurality of antennas, and couple a first receive signal of the first antenna of the plurality of antennas to the first receive switch through a first module switch, and the first module switch is configured to connect an input to the first module switch to a matched impedance during a first period of time, and connect the first receive signal of the first antenna of the plurality of antennas to the first receive switch during a second period of time. For an embodiment, the second antenna module includes a second circulator configured to couple a second transmit signal of the first transmit switch to a second antenna of the plurality of antennas, and couple a second receive signal of the second antenna of the plurality of antennas to the first receive switch through a second module switch, and the second module switch configured to connect an input to the second module switch to a matched impedance during the second period of time, and connect the second received signal of the second antenna of the plurality of antennas to the first receive switch during the first period of time.

For at least some embodiments, the first transmit switch is configured to connect the first transmit signal to the first antenna through the first antenna module during the first period, and configured to connect the second transmit signal to the second antenna through the second antenna module during the second period, and wherein the first receive switch is configured to connect the first receive signal of the second module to the RFSOC to during the first period, and configured to connect the second received signal of the first antenna module to the RFSOC during the second period.

Although specific embodiments have been described and illustrated, the embodiments are not to be limited to the specific forms or arrangements of parts so described and illustrated. The described embodiments are to only be limited by the claims.

What is claimed:

1. A transceiver system, comprising:
an RF system on a chip (RFSOC) comprising baseband communication circuitry, and frequency upconverters and frequency downconverters for transmit and received wireless signals;
a plurality of transmitter chains connected to a plurality of antennas;
a plurality of receiver chains connected to the plurality of antennas;
one or more transmit multiplexers, each of the one or more transmit multiplexers transmit multiplexers receiving transmit signals from the RFSOC through a single transmit line and generating transmit signals for a sub-plurality of the transmitter chains through multiple transmit lines, wherein the transmit signals include multiple transmission frequency bands; and
one or more receive multiplexers, each of the one or more receive multiplexers receiving receive signals from a sub-plurality of the receiver chains through multiple receive lines and providing the receive signals to the RFSOC through a single receive line, wherein the receive signals include multiple receive frequency bands.

2. The system of claim 1, wherein the RFSOC is operable at a high enough frequency to process the transmit signals having the multiple frequency bands and the receive signals having the multiple frequency bands.

3. The system of claim 1, wherein the transmit signals generate a separate transmission beam for each of the multiple transmission frequency bands, and a corresponding reception beam for one of the multiple receive frequency bands.

4. The system of claim 1, wherein each of the transmit multiplexers include electronic circuitry for frequency matching at each of the multiple transmission frequency bands.

5. The system of claim 1, wherein each of the receive multiplexers include electronic circuitry for frequency matching at each of the multiple receive frequency bands.

6. The system of claim 1, wherein each of the multiple transmission frequency bands has a corresponding one of the multiple receive frequency bands.

7. The system of claim 6, wherein a one of the transmitter chains operates to transmit a wireless signal through one of the multiple transmission frequency band simultaneous with a one of the receiver chains operating to receive a wireless signal through one of the multiple receive frequency bands.

8. The system of claim 1, further comprising:
a plurality transmit switches associated with each transmit multiplexer comprising:
a first transmit switch of the plurality of transmit switches operating to connect a first band of the multiple transmission frequency bands to a first transmitter chain of the plurality of transmitter chains or connect the first band of the multiple transmission frequency bands to a third transmitter chain of the plurality of transmitter chains;
a second transmit switch of the plurality of transmit switches operating to connect a second band of the multiple transmission frequency bands to a second transmitter chain of the plurality of transmitter chains or connect the second band of the multiple transmission frequency bands to a fourth transmitter chain of the plurality of transmitter chains.

9. The system of claim 8, further comprising:
a plurality receiver switches associated with each receive multiplexer comprising:
a first receiver switch of the plurality of receiver switches operating to connect a first band of the multiple receiver frequency bands from a first receive chain of the plurality of receiver chains associated with the first transmitter chain or connect the first band of the multiple transmission frequency bands from a third receiver chain of the plurality of receiver chains associated with the third transmitter chain;
a second receiver switch of the plurality of receiver switches operating to connect a second band of the multiple receiver frequency bands from a second receiver chain of the plurality of receiver chains associated with the second transmitter chain or connect the second band of the multiple receive frequency bands from a fourth receiver chain of the plurality of receiver chains associated with the fourth transmitter chain.

10. The system of claim 9, wherein the system comprises more transmit multiplexer when the system is configured to transmit wireless communication a majority of time, and wherein the system comprises more receive multiplexers when the system is configured to receive wireless communication a majority of time.

11. The system of claim 9, further comprising:
a first antenna module comprising:
a first circulator configured to couple a first transmit signal of the first transmit switch to a first antenna of the plurality of antennas, and couple a first receive signal of the first antenna of the plurality of antennas to the first receive switch through a first module switch;
the first module switch configured to connect an input to the first module switch to a matched impedance during a first period of time, and connect the first receive signal of the first antenna of the plurality of antennas to the first receive switch during a second period of time;
a second antenna module comprising:
a second circulator configured to couple a second transmit signal of the first transmit switch to a second antenna of the plurality of antennas, and couple a second receive signal of the second antenna of the plurality of antennas to the first receive switch through a second module switch;
the second module switch configured to connect an input to the second module switch to a matched impedance during the second period of time, and connect the second received signal of the second antenna of the plurality of antennas to the first receive switch during the first period of time.

12. The system of claim 11, wherein the first transmit switch is configured to connect the first transmit signal to the first antenna through the first antenna module during the first period, and configured to connect the second transmit signal to the second antenna through the second antenna module during the second period, and wherein the first receive switch is configured to connect the first receive signal of the second module to the RFSOC to during the first period, and configured to connect the second received signal of the first antenna module to the RFSOC during the second period.

13. A method, comprising:
frequency upconverting and frequency down-converting, by an RF system on a chip (RFSOC), transmit and received wireless signals;
receiving, by a plurality of transmit multiplexer, transmit signals from the RFSOC through a single transmit line and generating transmit signals for a sub-plurality of a plurality of transmitter chains through multiple transmit lines, wherein the transmit signals include multiple transmission frequency bands, wherein the plurality of transmitter chains are connected to a plurality of antennas; and
receiving, by a plurality of receive multiplexers, receive signals from a sub-plurality of the receiver chains through multiple receive lines and providing the receive signals to the RFSOC through a single receive line, wherein the receive signals include multiple receive frequency bands, wherein the plurality of receiver chains are connected to the plurality of antennas.

14. The method of claim 13, wherein the transmit signals generate a separate transmission beam for each of the multiple transmission frequency bands, and a corresponding reception beam for one of the multiple receive frequency bands.

15. The method of claim 13, wherein each of the multiple transmission frequency bands has a corresponding one of the multiple receive frequency bands.

16. The method of claim 15, wherein a one of the transmitter chains operates to transmit a wireless signal through one of the multiple transmission frequency band simultaneous with a one of the receiver chains operating to receive a wireless signal through one of the multiple receive frequency bands.

17. The method of claim 13, wherein a plurality transmit switches is associated with each transmit multiplexer, and further comprising:
connecting, by a first transmit switch of the plurality of transmit switches, a first band of the multiple transmission frequency bands to a first transmitter chain of the plurality of Transmitter chains or the first band of the multiple transmission frequency bands to a third transmitter chain of the plurality of Transmitter chains;
connecting, by a second transmit switch of the plurality of transmit switches, a second band of the multiple transmission frequency bands to a second transmitter chain of the plurality of transmitter chains or the second band of the multiple transmission frequency bands to a fourth transmitter chain of the plurality of Transmitter chains.

18. The method of claim 17, wherein a plurality receiver switches is associated with each receive multiplexer, and further comprising:
connecting, by a first receiver switch of the plurality of receiver switches, a first band of the multiple receiver frequency bands from a first receive chain of the plurality of receiver chains associated with the first transmitter chain or the first band of the multiple transmission frequency bands from a third receiver chain of the plurality of receiver chains associated with the third transmitter chain;
connecting, by a second receiver switch of the plurality of receiver switches, a second band of the multiple receiver frequency bands from a second receiver chain of the plurality of receiver chains associated with the second transmitter chain or the second band of the multiple receive frequency bands from a fourth receiver chain of the plurality of receiver chains associated with the fourth transmitter chain.

19. The method of claim 18, further comprising:
coupling, by a first circulator of a first antenna module, a first transmit signal of the first transmit switch to a first antenna of the plurality of antennas, and coupling, by a first circulator of a first antenna module, a first receive signal of the first antenna of the plurality of antennas to the first receive switch;
connecting, by the first module switch, an input to the first module switch to a matched impedance during a first period of time, and connecting, by the first module switch, the first receive signal of the first antenna of the plurality of antennas to the first receive switch during a second period of time;
coupling, by a second circulator a second antenna module, a second transmit signal of the first transmit switch to a second antenna of the plurality of antennas, and coupling, by a second circulator a second antenna module, a second receive signal of the second antenna of the plurality of antennas to the first receive switch;
connecting, by the second module switch, an input to the second module switch to a matched impedance during the second period of time, and connecting, by the second module switch, the second received signal of the second antenna of the plurality of antennas to the first receive switch during the first period of time.

20. The method of claim 19, wherein the first transmit switch is configured to connect the first transmit signal to the first antenna through the first antenna module during the first period, and configured to connect the second transmit signal to the second antenna through the second antenna module during the second period, and wherein the first receive switch is configured to connect the first receive signal of the second module to the RFSOC to during the first period, and configured to connect the second received signal of the first antenna module to the RFSOC during the second period.
